(19) United States
(12) Patent Application Publication
(10) Pub. No.: US 2016/0257331 A1
(43) Pub. Date: Sep. 8, 2016

(54) CONVERTIBLE TODDLER PLATFORM

(71) Applicant: NUSKE ENTERPRISES PTY LTD, Tewantin, Queensland (AU)

(72) Inventor: Jodi NUSKE, Tewantin, Queensland (AU)

(21) Appl. No.: 15/029,165

(22) PCT Filed: Oct. 15, 2014
(86) PCT No.: PCT/AU2014/000972

§ 371 Date: Apr. 13, 2016

(30) Foreign Application Priority Data
Oct. 15, 2013 (AU) 2013903970
May 27, 2014 (AU) 2014902003

(51) Int. Cl. B62B 9/12; B62B 9/28

(52) U.S. Cl. CPC B62B 9/12; B62B 9/28

(57) ABSTRACT

A convertible toddler platform including a platform having at least one wheel mounted to an underside of the platform, a pair of mounting arms extending forwardly from a mounting portion provided at a front end of the platform for connecting the platform to a pram or stroller and a storage basket integrated with the platform which is released from a closed stored configuration to an open expanded configuration via a release mechanism provided on the platform.

### FIELD OF THE INVENTION

The present invention relates to accessories and attachments for prams and strollers. In particular, but not exclusively, the present invention relates to a convertible toddler platform attachment for a pram or stroller which provides a standing platform and additional storage. However, it will be appreciated that the present invention has broader application and is not limited to that particular use.

### BACKGROUND TO THE INVENTION

Prams and strollers are built and sold with the intention of conveying a single child in a seated position. Families or childcare givers that start with a stroller for one child only and then have a second child are faced with a problem of only being able to seat one of the children should they need to transport both.

Solutions available to the parents and childcare givers include: obtaining a second stroller, obtaining a larger stroller to seat the extra child to double or triple stroller), having one child walk or be carried, or obtaining a wheeled device that attaches to the back of the stroller upon which the additional child can stand. Examples of wheeled devices include the Bugaboo Wheeled Board and the Lascal Buggy Board.

U.S. Pat. No. 7,971,884 discloses a standing board for prams which is fastened to a pram via connecting arms that protrude from the standing board with connectors at their outer ends. The connecting arts are moveable horizontally along the front edge of the standing board to vary the distance between the connecting arms and are rotatable to vary the angle of the arms relative to the standing board. The connectors are also pivotable to facilitate connection of the standing board to the stroller.

United States Patent Publication No. 20070090619 discloses a standing board comprising a board, wheels and two mounting arms which are directed diagonally forward for connecting the board to prams. The mounting arms are connected to the board via a transverse bar along which the mounting arms can be moved. The bar can pivot around its axis and comprises at least two parts that can be moved longitudinally in relation to each other. The bar can be locked in one of several positions to adjust it to the appropriate width to match the width to the pram with which the standing board is to be used.

U.S. Pat. No. 6,827,356 discloses a rear carrying board assembly of a stroller comprising a body, two joint devices, two connecting devices, and two shock absorbing devices which is mounted on the rear portion of the stroller for supporting the baby or for placing an article, thereby enhancing the versatility of the stroller.

U.S. Pat. No. 8,029,007 discloses a stroller passenger assembly comprising a platform mounted upon a chassis, upon which two casters are attached. The casters may be adjustable for height. Extending outward and away from the chassis is at least one, ideally two, attachment arms for interconnecting with a stroller frame. The chassis assembly is rotatable to adjust the position of the attachment arms relative to the platform and, consequently, the stroller frame. In the preferred embodiment, handlebar extensions are provided for easier control of the stroller given the tendency of the platform alone to obstruct a user from achieving proximity necessary for comfortable, efficient and effective control of the stroller. Additional modules such as a seat or storage compartment can be placed on the platform and be attached to the chassis assembly via straps or bands or the like for carrying load bearing utility when shopping. However, these modules are provided as an additional unit and must be carried separate to the passenger assembly.

In this respect, the toddler platform according to the present invention departs substantially from the usual designs in the prior art. In doing so, this invention provides an adaptable passenger assembly utilizable on all types of strollers. The invention also provides such adaptability in a convenient manner, and in a manner that is readily removed from one stroller and utilizable on a stroller of another type. Furthermore, the present invention provides an additional storage functionality which is integrated into the toddler platform for use when required.

In this specification, the terms “comprises”, “comprising” or similar terms are intended to mean a non-exclusive inclusion, such that a convertible toddler platform that comprises a list of elements does not include those elements solely, but may well include other elements not listed.

### OBJECT OF THE INVENTION

It is a preferred object of the present invention to provide a convertible toddler platform, that addresses or at least ameliorates one or more of the aforementioned problems of the prior art and/or provides a consumer with a useful or commercial choice.

### SUMMARY OF THE INVENTION

Generally, embodiments of the present invention relate to a convertible toddler platform attachment for a pram or stroller which can be used as a standing platform or a storage basket.

According to one aspect, although not necessarily the broadest aspect, the present invention resides in a convertible toddler platform comprising:

a platform having at least one wheel mounted to an underside of the platform;

a pair of mounting arms extending forwardly from a mounting portion provided at a front end of the platform for connecting said platform to a pram or stroller; and

a storage basket integrated with the platform which is released from a closed stored configuration to an open expanded configuration via a release mechanism provided on the platform.

Preferably, the platform comprises a supporting surface hingedly attached to a supporting base at a rear end of the platform.

Preferably, the platform has a pair of wheels mounted to the underside at the rear end of the platform, with one wheel mounted at each rear corner.

Preferably, the platform comprises a mounting portion integrally formed with the front end of the platform.

Preferably, the mounting portion houses an adjustable bar therein.

Preferably, the mounting portion is formed having an upper portion and a lower portion which can be tightened to grip and hold the adjustable bar in one of several positions, or be loosened to release the adjustable bar.

Preferably, at least one lever is provided on the mounting portion utilised to tighten or loosen the mounting portion.

Preferably, the adjustable bar is rotatably and laterally adjustable such that it can rotate about its axis in relation to the platform and slide laterally within the mounting portion such that the pair of mounting arms mounted thereto will follow the adjustable bar's rotational and lateral movement.

Preferably, the mounting arms are telescopic, comprising at least two parts where a first part can be moved longitudinally in direction in relation to a second part.

Preferably, the mounting arms comprise a connecting portion, wherein a first end of the connecting portion is detachably connected to a first part of the mounting arm and a second end of the connecting portion is detachably connected to a pram or stroller.

Preferably, the connecting portion comprises a flexible strap adapted to connect to a frame of a pram or stroller.

Preferably, the storage basket is collapsible and is stored beneath the supporting surface of the platform when not in use.

Preferably, the storage basket is attached to an underside of the supporting surface via at least one securing strap to support the storage basket in an open expanded configuration.

Further features and forms of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 shows a rear perspective view of a convertible toddler platform according to an embodiment of the present invention;

FIG. 2 shows a front perspective view of part of the convertible toddler platform of FIG. 1;

FIG. 3 shows a partial exploded view of a pair of mounting arms of the convertible toddler platform of FIG. 1;

FIG. 4 shows a side perspective view of the mounting arm of the convertible toddler platform of FIG. 1;

FIG. 5 shows a side perspective view of a connecting portion of the convertible toddler platform of FIG. 1;

FIG. 6 shows a side perspective view of the connecting portion of FIG. 5 connected to a pram or stroller frame; and

FIG. 7 shows a front perspective view of the convertible toddler platform of FIG. 1 wherein a platform of the convertible toddler platform is converted into a shopping basket.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

Embodiments of the present invention will be described with reference to a convertible toddler platform which can be used as a standing platform or a storage basket. For convenience sake, the convertible toddler platform will be described herein as an attachment for a pram, stroller, pushchair, buggy or the like. However, it should be appreciated that embodiments of the present invention can be modified to suit any suitable push-type carrier or passenger assembly for children. It will be appreciated that variations may need to be made as required. It will be acknowledged that the style, colour and dimensions of the convertible toddler platform and/or its components can be varied to suit different carriers and assemblies, requirements and/or consumer preferences.

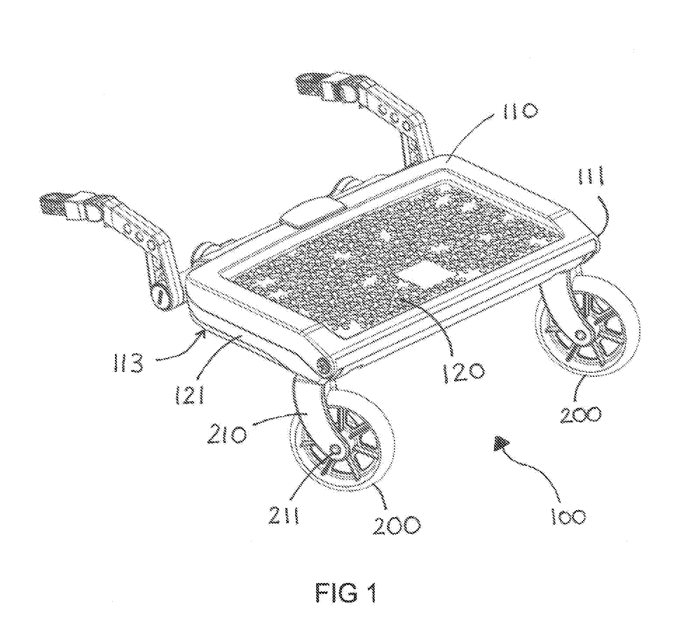

Referring to FIG. 1, the convertible toddler platform 100 is provided in accordance with embodiments of the present invention. According to some embodiments the convertible toddler platform 100 is primarily made of a durable plastics material for safety and durability. However, it is envisaged that any other suitable material may also be adopted and/or used in combination therewith. The convertible toddler platform 100 comprises a platform 110 having a supporting surface 120 for a child to be transported thereon. The platform 110 comprises the supporting surface 120 which is hingedly attached to a supporting base 121 at a rear end 111 of the platform 110. The platform 110 is substantially rectangular in shape. However, it is envisaged that any other suitable shape may also be adopted. The dimensions of the platform 110 are sufficient for enabling a child to stand steadily, preferably with feet at least shoulder width apart, and be supported on the platform 110 with enough room in front and behind the foot of the child.

The convertible toddler platform 100 has at least one wheel 200 mounted to an underside 113 of the platform 110. The platform 110 has a pair of wheels 200 mounted to the underside 113 at a rear end 111 of the platform 110, with one wheel 200 mounted at each rear corner of the platform 110. The wheels 200 are mounted to the underside 113 of the platform 110 via a bracket 210, comprising at least one fastening member such as a screw or bolt or the like to secure the wheel 200 thereto, or any other suitable means of attachment which enables them to rotate freely. The wheels 200 can rotate around their respective axles and twist, pivot or rotate around their fastenings in an axle at a right angle to the platform 110. The wheels 200 can be of a plastic or rubber material. However, any other suitable material may also be adopted. In an alternative embodiment of the present invention, it is envisaged that a suspension mechanism can also be incorporated into the wheel attachment to provide additional comfort for a passenger. In a further embodiment, it is envisaged that the wheels 200 can have a suitable tread pattern provided on their surface.

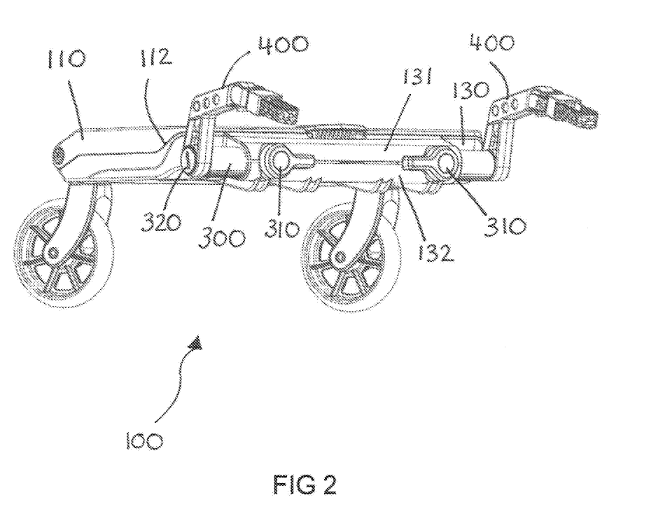

Referring now to FIG. 2, the platform 110 of the convertible toddler platform 100 comprises a mounting portion 130 which is integrally formed with a front end 112 of the platform 110. The mounting portion 130 extends outwardly from the front end 112 of the platform 110 in a direction generally parallel to the front end 112 of the platform 110. The mounting portion 130 is adapted to house an adjustable bar 300 therein. As illustrated in FIG. 2, the mounting portion 130 is formed having an upper portion 131 and a lower portion 132 which can be tightened via at least one lever 310 to grip and hold the adjustable bar 300 in one of several positions, or be loosened to release the adjustable bar 300. A pair of levers 310, is provided on the mounting portion 130 which is utilised to tighten or loosen the mounting portion 130. The pair of levers 310 is in the form of a quarter turn twisting lever which is movable between a first locked position where the lever 310 lies parallel to the platform 110 and a second unlocked position where the lever 310 lies perpendicular to the platform 110. The bar 300 is rotatably and laterally adjustable such that it can rotate about its axis in relation to the platform 110 and slide laterally within the mounting portion 130. A pair of mounting arms 400 mounted thereto are designed to follow the adjustable bar's 300 rotational and lateral movement such that the pair of mounting arms 400 can accommodate different pram and pushchair designs.

The pair of mounting arms 400 extend forwardly from the front end 112 of the platform 110 for connecting said platform 110 to a pram or stroller. The mounting arms 400 are connected to the platform 110 via the adjustable bar 300. The mounting arms 400 are connected to either end of the adjustable bar 300 via a quarter turn moulding or key 320. However, it is envisaged that any other suitable fastener may also be adopted, such as a plastic screw or the like. The adjustable bar 300 can pivot about its axis in relation to the platform 110 and the mounting arms 400 are designed to follow the rotational movement of the bar 300.

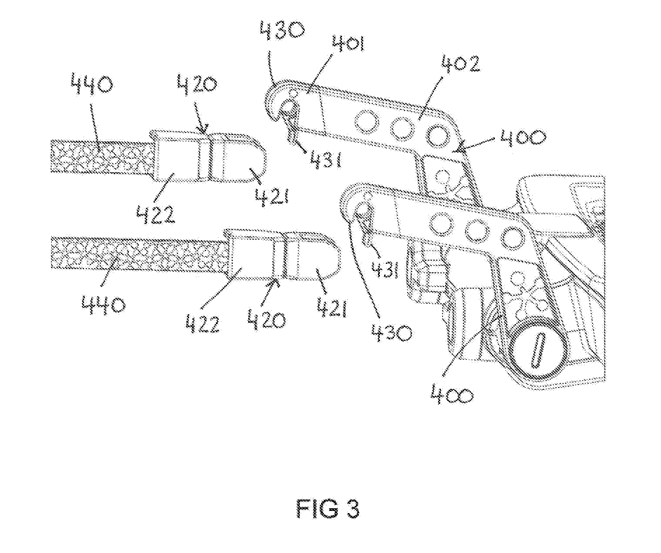

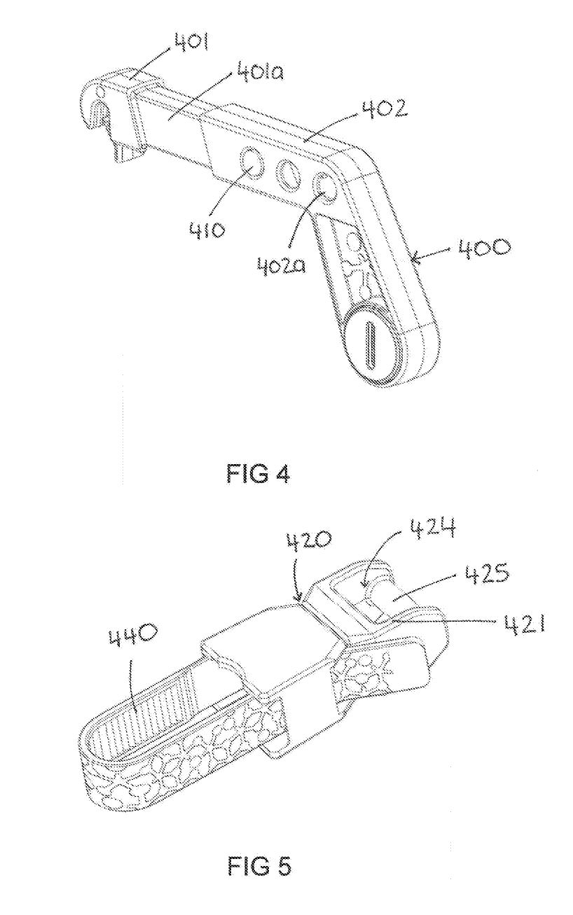

Referring now to FIGS. 3 and 4, the mounting arms 400 are telescopic, comprising at least two parts 401, 402, wherein a first part 401 can be moved longitudinally in relation to a second part 402. As illustrated in FIG. 4, the first part 401 of the mounting arm 400 comprises a shaft 401a which is adapted to be slidably received within a body of a second part 402 of the mounting arm 400. A securing/release button 410 is provided which is adapted to lock the shaft 401a of the first part 401 and prevent it from being extended and/or retracted within the body of the second part 402. The securing/release button 410 is in the form of a depressible button which is moveable between a first locked position wherein the button 410 extends outwardly through at least one aperture 402a provided on the second part 402 and a second unlocked position wherein the securing/release button 410 is pressed and retracted within the aperture 402a to enable the first part 401 to be movable in a longitudinal direction relative to the second part 402 of the mounting arm 400.

Referring to FIG. 3, the mounting arms 400 each comprise a connecting portion 420. A first end 421 of the connecting portion 420 is detachably connected to the first part 401 of the mounting arm and a second end 422 of the connecting portion 420 allows connection to a pram or stroller via a flexible strap 440. However, in an alternative embodiment it is envisaged that the connecting portions 420 may be integrally formed with the mounting arms 400. The first part 401 of the mounting arm 400 has a hook-shaped clamp 430 to connect the connecting portion 420 to the first part 401 of the mounting arm 400. A release lever 431 is provided on the first part 401 which can be pressed or pulled back to release the connecting portion 420 from damp 430. As illustrated more dearly in FIG. 5, the first end 421 of the connecting portion is substantially u-shaped to provide a recess 424 and comprises a rod 425 for receiving the hook shaped clamp 430 of the first part 401 of the mounting arm 400.

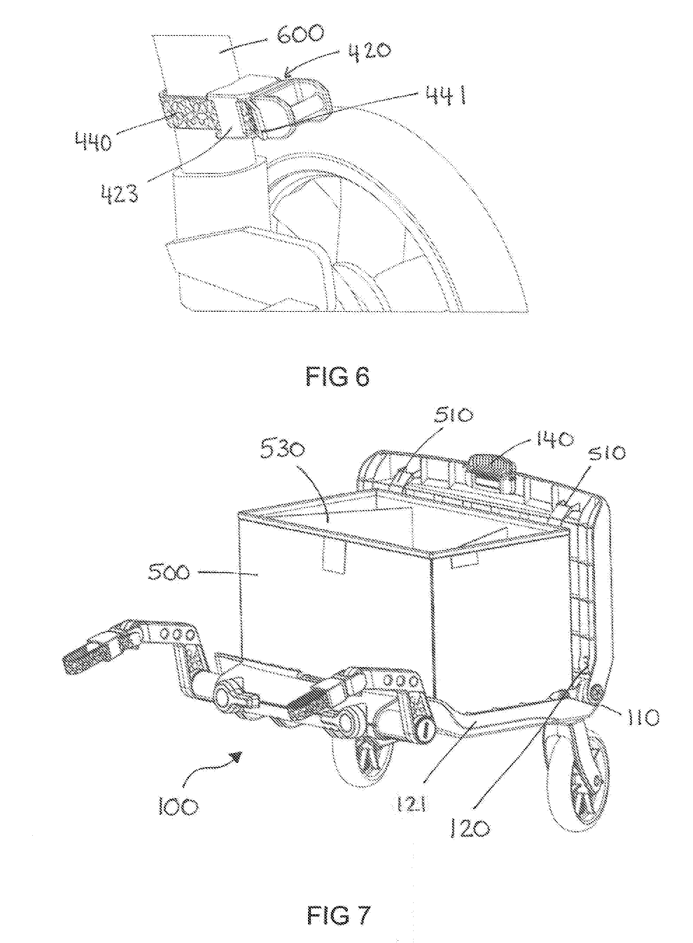

Referring to FIG. 6, the connecting portion 420 comprises the flexible strap 440 which is adapted to connect to a pram or stroller frame 600. The flexible strap 440 is secured in position by threading a free end 441 of the flexible strap 440 through a retaining portion 423 provided on the connecting portion 420. In an alternative embodiment of the present invention, any other suitable securing mechanism may also be employed. The connecting portion 420 can be removed or remain connected to the pram or stroller for convenience so that the convertible toddler platform 100 can be easily attached and detached as required.

Referring now to FIG. 7, the convertible toddler platform 100 comprises a storage basket 500 which is integrated with the platform 110. The storage basket 500 is designed to be collapsible and is stored beneath the supporting surface 120 of the platform when not in use. The storage basket 500 is preferably made of a fabric material or any other suitable material which is flexible and easily collapsible without requiring much space. In an alternative embodiment, it is envisaged that the storage basket 500 could be made of a plastic material to be more durable. It is envisaged that the storage basket 500 can have any suitable print or design to suit different user preferences.

The convertible toddler platform 100 comprises a release mechanism 140 which is adapted to convert the platform 110 into a storage basket. The storage basket 500 is attached to the support surface 120 and/or the supporting base 121 to securely hold it in place. As illustrated in FIG. 7, the storage basket 500 is attached to an underside of the supporting surface 120 via at least one securing strap 510 to support the storage basket 500 in an open expanded position. It is envisaged that the storage basket 500 comprises at least one support panel 530 which can be folded out to complete and/or provide reinforcement for the side walls of the storage basket 500.

As illustrated in FIG. 7, the release mechanism 140 is in the form of a press release latch which enables the supporting surface 120 of the platform 110 to open outwardly from a closed stored configuration into an open expanded configuration such that it lies upright and perpendicular in relation to the supporting base 121 of the platform 110. In an alternative embodiment, it is envisaged that any other suitable release mechanism may also be employed. When no longer required, the supporting surface 120 can be pushed downwardly to collapse the storage basket 500 back into the closed storage configuration and lock the release mechanism 140 by allowing the latch to click into a locked position.

Hence, the convertible toddler platform provides a solution to the aforementioned problems of the prior art by providing a convertible toddler platform attachment for a pram or stroller which can be used as a standing platform and/or a storage basket. The convertible toddler platform of the present invention provides an adaptable passenger assembly utilizable on all types of strollers. The present invention also provides such adaptability in a convenient manner, and in a manner that is readily removed from one stroller and utilizable on a stroller of another type. Furthermore, the present invention provides an additional storage functionality which is incorporated into the toddler platform for use when required.

The reference to any prior art in this specification is and should not be taken as, an acknowledgment or any form or suggestion that the prior art forms part of the common general knowledge.

Throughout the specification the aim has been to describe the invention without limiting the invention to any one embodiment or specific collection of features. Persons skilled in the relevant art may realize variations from the specific embodiments that will nonetheless fall within the scope of the invention.

1. A convertible toddler platform comprising:
a platform having at least one wheel mounted to an underside of the platform;
a pair of mounting arms extending forwardly from a mounting portion provided at a front end of the platform for connecting said platform to a pram or stroller; and
a storage basket integrated with the platform which is released from a closed stored configuration to an open expanded configuration via a release mechanism provided on the platform.

2. The convertible toddler platform of claim 1, wherein the platform comprises a supporting surface hingedly attached to a supporting base at a rear end of the platform.

3. The convertible toddler platform of claim 1, wherein the platform has a pair of wheels mounted to the underside at the rear end of the platform, with one wheel mounted at each rear corner.

4. The convertible toddler platform of claim 1, wherein the platform comprises a mounting portion integrally formed with the front end of the platform.

5. The convertible toddler platform of claim 1, wherein the mounting portion is adapted to house an adjustable bar therein.

6. The convertible toddler platform of claim 5, wherein the mounting portion is formed having an upper portion and a lower portion which can be tightened to grip and hold the adjustable bar in one of several positions, or be loosened to release the adjustable bar.

7. The convertible toddler platform of and one of claim 1, wherein at least one lever is provided on the mounting portion utilised utilized to tighten or loosen the mounting portion.

8. The convertible toddler platform of claim 6, wherein the bar is rotatably and laterally adjustable such that it can rotate about its axis in relation to the platform and slide laterally within the mounting portion such that the pair of mounting arms mounted thereto will follow the adjustable bar's rotational and lateral movement.

9. The convertible toddler platform of claim 1, wherein the mounting arms are telescopic, comprising at least two parts where a first part can be moved longitudinally in direction in relation to a second part.

10. The convertible toddler platform of claim 1, wherein the mounting arms comprise a connecting portion, wherein a first end of the connecting portion is detachably connected to a first part of the mounting arm and a second end of the connecting portion is detachably connected to a pram or stroller.

11. The convertible toddler platform of claim 10, wherein the connecting portion comprises a flexible strap adapted to connect to a frame of a pram or stroller.

12. The convertible toddler platform of claim 1, wherein the storage basket is collapsible and is stored beneath the supporting surface of the platform when not in use.

13. The convertible toddler platform of claim 1, wherein the storage basket is attached to an underside of the supporting surface via at least one securing strap to support the storage basket in an open expanded configuration.
